(19) United States
(12) Patent Application Publication
(10) Pub. No.: US 2020/0150912 A1
(43) Pub. Date: May 14, 2020

(54) IMAGE FORMING DEVICE, NON-TRANSITORY COMPUTER-READABLE RECORDING MEDIUM STORING CONTROL PROGRAM, AND CONTROL METHOD

(71) Applicant: SHARP KABUSHIKI KAISHA, Sakai City (JP)

(72) Inventor: AKIRA OGAWA, Sakai City (JP)

(21) Appl. No.: 16/675,878

(22) Filed: Nov. 6, 2019

(30) Foreign Application Priority Data
Nov. 9, 2018 (JP) 2018-211404

(51) Int. Cl. G06F 3/12

(52) U.S. Cl. CPC G06F 3/1255; G06F 3/1239; G06F 3/1256; G06F 3/1205; G06F 3/1231; G06F 3/1204

(57) ABSTRACT

An image forming device includes a central processing unit (CPU), and is provided with a display having a touch panel. When a restriction condition is met that results in color printing becoming unusable, a copy setting screen, in which a function selection key for setting a color mode and a color start key are not displayed, is displayed on the display.

### BACKGROUND OF THE INVENTION

### Field of the Invention

The present invention relates to an image forming device, a non-transitory computer-readable recording medium storing a control program, and a control method. In particular, for example, the present invention relates to an image forming device, a non-transitory computer-readable recording medium storing a control program, and a control method capable of selectively executing monochrome printing and color printing.

### Description of the Background Art

An example of related art of this type is disclosed in Japanese Unexamined Patent Application Publication No. 2005-217495. In the image processing device of the related art, when a color start key or a monochrome start key is pressed, it is determined whether or not the pressed key is usable. If the key is not usable, then a message indicating that the key is not usable is displayed.

### SUMMARY OF THE INVENTION

However, in the image processing device of the related art, it is assumed that a color start key or a monochrome start key is pressed. Therefore, it is not possible to prevent erroneous operations, such as the pressing of an unusable key, ahead of time.

Therefore, the main object of the present invention is to provide a new image forming device, non-transitory computer-readable recording medium storing a control program, and control method.

Another object of the present invention is to provide an image forming device, a non-transitory computer-readable recording medium storing a control program, and a control method which are capable of preventing erroneous operations ahead of time.

### Means for Solving the Problem

One aspect of the invention is an image forming device capable of executing monochrome printing and color printing, including: an operation screen displaying unit that displays an operation screen relating to a copy function; a restriction condition determinator that determines whether or not the restriction condition that restricts the use of a function of the color printing within the copy function is met; and a non-displaying unit that causes information relating to the function of the color printing to not be displayed on the operation screen if the restriction condition determinator determines that the restriction condition is met.

Another aspect of the invention belongs to the above aspect of the invention, wherein the restriction condition includes a first condition, which indicates that a setting that causes the function of the color printing within the copy function to be unusable has been set, the restriction condition determinator determines whether or not the first condition is met, and the non-displaying unit causes information relating to the function of the color printing to not be displayed on the operation screen if the restriction condition determinator determines that the first condition is met.

Still another aspect of the invention belongs to the above aspect of the invention, the restriction condition includes a second condition, which indicates that a setting that causes the function of the color printing within the image forming device to be unusable has been set, the restriction condition determinator determines whether or not the second condition is met, and the non-displaying unit causes the information relating to the function of the color printing to not be displayed on the operation screen if the restriction condition determinator determines that the second condition is met.

Still another aspect of the invention belongs to any one of the above aspects of the invention, wherein the restriction condition includes a third condition, which indicates that an upper limit has been set with respect to the number of sheets capable of being printed by the color printing, the restriction condition determinator determines whether or not the third condition is met, an upper limit determinator is further provided that determines whether or not the upper limit with respect to the number of sheets capable of being printed by the color printing has been reached if the restriction condition determinator determines that the third condition is met, and the non-displaying unit causes the information relating to the function of the color printing to not be displayed on the operation screen if the upper limit determinator determines that the upper limit with respect to the number of sheets capable of being printed by the color printing has been reached.

Still another aspect of the invention belongs to any one of the above aspects of the invention, wherein the restriction condition includes a fourth condition, which indicates that an error that prevents only the color printing from being executed has occurred, the restriction condition determinator determines whether or not the fourth condition is met, and information relating to the function of the color printing is not displayed on the operation screen if the restriction condition determinator determines that the fourth condition is met.

Still another aspect of the invention belongs to any one of the above aspects of the invention, wherein the information relating to the function of the color printing includes first operation information for instructing execution of the color printing within the copy function, and second operation information for performing settings relating to the color printing.

Still another aspect of the invention belongs to any one of the above aspects of the invention, further including a scan executor that executes scanning of a document, a preview image displaying unit that displays a preview image corresponding to the document scanned by the scan executor, wherein the preview image displaying unit displays the preview image corresponding to the document scanned by the scan executor in grayscale, irrespective of whether or not the document is a color document, if the restriction condition determinator determines that the restriction condition is met.

Still another aspect of the invention is a non-transitory computer-readable recording medium storing a control program of an image forming device capable of executing monochrome printing and color printing, the control program causing a processor of the image forming device to execute: displaying of an operation screen relating to a copy function on a displaying unit; determining of a restriction condition in which it is determined whether or not a restriction condition that restricts the use of a function of the color printing within the copy function is met; and making of information relating to the function of the color printing not displayed on the operation screen if it is determined in the determining of the restriction condition that a restriction condition is met.

Still another aspect of the invention is a control method of an image forming device capable of executing monochrome printing and color printing, including: (a) displaying of an operation screen relating to a copy function on a displaying unit; (b) determining of a restriction condition in which it is determined whether or not a restriction condition that restricts the use of a function of the color printing within the copy function is met; and (c) making of information relating to the function of the color printing not displayed on the operation screen if it is determined in (b) that a restriction condition is met.

### Effects of the Invention

According to the present invention, erroneous operations can be prevented ahead of time.

The object above, other objects, features and advantages of the present invention will become more apparent from the detailed description of the following embodiment given with reference to the drawings.

### BRIEF DESCRIPTION OF THE DRAWINGS

FIG. 1 is a perspective view showing an external configuration of an image forming device, which is an embodiment of the present invention.

FIG. 2 is a block diagram showing an electrical configuration of the image forming device shown in FIG. 1.

FIG. 3 is a diagram showing a first example of a copy setting screen.

FIG. 4 is a diagram showing a second example of a copy setting screen.

FIG. 5 is a diagram showing a first example of a preview screen.

FIG. 6 is a diagram showing a second example of a preview screen.

FIG. 7 is a diagram showing a third example of a copy setting screen.

FIG. 8 is a diagram showing a fourth example of a copy setting screen.

FIG. 9 is a diagram showing a fifth example of a copy setting screen.

FIG. 10 is a diagram showing a sixth example of a copy setting screen.

FIG. 11 is a diagram showing a third example of a preview screen.

FIG. 12 is a diagram showing a fourth example of a preview screen.

FIG. 13 is a diagram showing an example of a memory map of a random access memory (RAM) shown in FIG. 2.

FIG. 14 is a flow diagram showing a first part of an example of processing relating to the copy function of a central processing unit (CPU) shown in FIG. 2.

FIG. 15 is a flow diagram which follows on from FIG. 14, showing a second part of the processing relating to the copy function of the CPU shown in FIG. 2.

FIG. 16 is a flow diagram which follows on from FIG. 15, showing a third part of the processing relating to the copy function of the CPU shown in FIG. 2.

FIG. 17 is a flow diagram which follows on from FIG. 15 and FIG. 16, showing a fourth part of the processing relating to the copy function of the CPU shown in FIG. 2.

FIG. 18 is a flow diagram which follows on from FIG. 17, showing a fifth part of the processing relating to the copy function of the CPU shown in FIG. 2.

FIG. 19 is a flow diagram which follows on from FIG. 17, showing a sixth part of the processing relating to the copy function of the CPU shown in FIG. 2.

FIG. 20 is a flow diagram which follows on from FIG. 17, showing a seventh part of the processing relating to the copy function of the CPU shown in FIG. 2.

FIG. 21 is a flow diagram which follows on from FIG. 20, showing an eighth part of the processing relating to the copy function of the CPU shown in FIG. 2.

### DESCRIPTION OF THE PREFERRED EMBODIMENTS

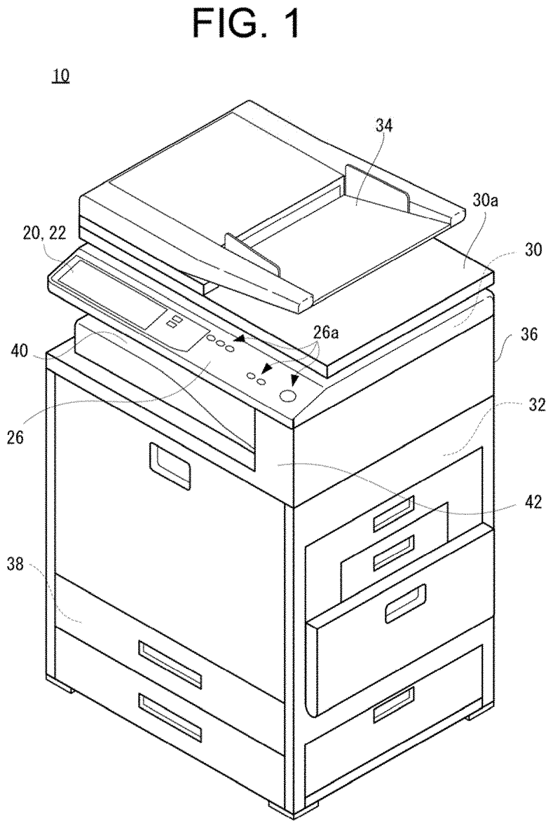

FIG. 1 is a perspective view showing an external configuration of an image forming device 10, which is an embodiment of the present invention. Referring to FIG. 1, the image forming device 10 in the present embodiment is a multifunction peripheral (MFP) which includes a copy function, a printer function, a scanner function, a facsimile function, and the like.

The present invention is applicable not only to multifunction peripherals, but also to other image forming devices provided with at least a copier (copy machine).

Furthermore, in the present specification, the front-and-rear direction (depth direction) of the image forming device 10 and the constituent members thereof is defined such that the front surface (front) is the surface facing the user operating the image forming device 10, that is to say, the surface on the side provided with the operation panel 26 described below. Further, the left-and-right direction (width direction) of the image forming device 10 and the constituent elements thereof is defined based on the user's view of the image forming device 10.

The image forming device 10 is provided with a device body 36 which includes an image reader 30, an image former 32, a manual document feeder 34, a sheet feeding device 38, and a paper discharge tray 40.

The image reader 30 includes a document placement table formed of a transparent material, and is built into the device body 36. A document holding cover 30a is attached to the top of the document placement table such that it can be freely opened and closed via a hinge or the like. The document holding cover 30a is provided with a manual document feeder 34. Furthermore, the document holding cover 30a is provided with an automatic document feeder (ADF) that automatically feeds a document placed on the manual document feeder 34.

Moreover, the image reader 30 includes a light source, a plurality of mirrors, an imaging lens, a line sensor, and the like. The image reader 30 exposes the surface of the document to the light source, and guides the reflected light from the surface of the document to the imaging lens by means of the plurality of mirrors. Then, the reflected light is imaged on a light-receiving element of the line sensor by the imaging lens. The line sensor detects the luminance or the chromaticity of the reflected light imaged on the light-receiving element, and generates read image data based on the image on the document surface. A charge coupled device (CCD), a contact image sensor (CIS), or the like is used as the line sensor.

The image former 32 is built into the device body 36, and is provided below the image reader 30. The image former 32 includes a photosensitive drum, a charging device, an exposure device, a developing device, a transfer device, a fixing device and the like. The image former 32 forms an image on the recording medium (sheet) transported from the sheet feeding device 38 or the like by the electrophotographic method, and discharges the sheet to the paper discharge tray 40 following image formation. Note that the read image data which has been read by the image reader 30, image data transmitted from an external computer, or the like, is used as the output image data for forming the image on the sheet. Furthermore, the recording medium is not limited to sheets made of paper, and sheets made of materials other than paper, such as overhead projector (OHP) films, may be used.

Although the detailed description is omitted, the image forming device 10 includes a function of the color printing. The image former 32 includes four photosensitive drums, four charging devices, four developing devices, four intermediate transfer rollers, four cleaning devices, and the like, which correspond to each of the colors yellow (Y), magenta (M), cyan (C), and black (K). Furthermore, an image forming station including a photosensitive drum, a charging device, a developing device, a transfer roller, and a cleaning device is configured for each color. The image forming device 10 is a tandem-type image forming device in which the image forming stations for each color are disposed side-by-side in the image former 32.

The paper discharge tray 40 is provided between the image reader 30 and the image former 32. The bottom surface of the paper discharge tray 40 is partitioned by the image former 32. Furthermore, the top surface of the paper discharge tray 40 is partitioned by the image reader 30. In addition, the left side surface of the paper discharge tray 40 (the left side surface when viewed from the front) is defined by the right side surface of a joined casing 42. That is to say, the front surface side, the rear surface side, and the left surface side of the paper discharge tray 40 are open. The bottom surface of the paper discharge tray 40 has an inclined surface which is downwardly inclined toward the joined casing 42 side.

Furthermore, an operation panel 26 is provided on the front surface side of the image reader 30. The operation panel 26 includes a display 22 having a touch panel 20, and a plurality of operation buttons 26a.

The display 22 having the touch panel 20 displays software keys, which accept various settings and printing instructions from the user, and messages and the like. As an example, the display 22 displays operation screens such as a home screen, which is a screen for selecting a desired job from among various jobs (or functions) capable of being executed by the image forming device 10, and a setting screen for setting the operation conditions for each job. Note that, in the present embodiment, a job refers to a copying (including document scanning) job, a printing job, a fax transmission job, and the like.

The operation buttons 26a are hardware keys which include, for example, a home key, a power reduction key, and a main power key. The home key is a key for displaying the home screen on the display 22. Note that the home screen is a screen for selecting a job. The power key is a key for switching between a power reduction state (hereinafter, referred to as “power reduction mode”) in which the power consumption is restricted, and a normal state (hereinafter, referred to as “normal mode”) in which the power consumption is not restricted.

A software key refers to, for example, a key or icon reproduced by software on the display surface of the display 22 having the touch panel 20. In contrast, a hardware key refers to a key or push button provided as a physical device.

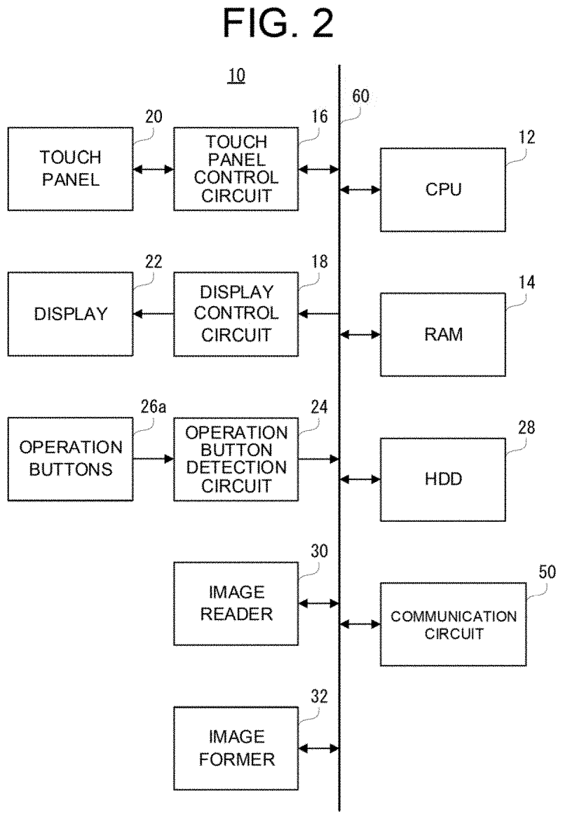

FIG. 2 is a block diagram showing an electrical configuration of the image forming device 10 shown in FIG. 1. Referring to FIG. 2, the image forming device 10 includes a central processing unit (CPU) 12. The CPU 12 is connected via a bus 60 to a random access memory (RAM) 14, a hard disk drive (HDD) 28, a touch panel control circuit 16, a display control circuit 18, an operation button detection circuit 24, an image reader 30, an image former 32, and a communication circuit 50. Furthermore, the touch panel control circuit 16 is connected to the touch panel 20. The display control circuit 18 is connected to the display 22. The operation button detection circuit 24 is connected to the operation buttons 26a.

The CPU 12 performs the overall control of the image forming device 10. The RAM 14 is used as a work area and a buffer area of the CPU 12. The HDD 28 is the primary storage device of the image forming device 10, and appropriately stores: control programs that enable the CPU 12 to control the operation of each part of the image forming device 10; display image data relating to various screens; data relating to setting content that has been set with respect to the image forming device 10; and data relating to the number of sheets which has been printed using the copy function of the image forming device 10. Note that another type of non-volatile memory, such as a solid state drive (SSD), a flash memory, or an electrically erasable programmable read-only memory (EEPROM), may be used instead of the HDD 28, or together with the HDD 28.

The touch panel control circuit 16 applies the necessary voltage and the like to the touch panel 20. It also detects touch operations or touch inputs inside a touch-effective area of the touch panel 20, and outputs to the CPU 12 touch coordinate data indicating the positions of the touch inputs.

The touch panel 20 is a general-purpose touch panel, and an arbitrary type such as an electrostatic capacitance-type, electromagnetic induction-type, resistance film-type, or infrared-type touch panel may be used. In the present embodiment, an electrostatic capacitance-type touch panel is used as the touch panel 20, and the touch panel 20 is provided on the display surface of the display 22. Note that a touch panel display may be used, in which the touch panel 20 and the display 22 are integrally formed.

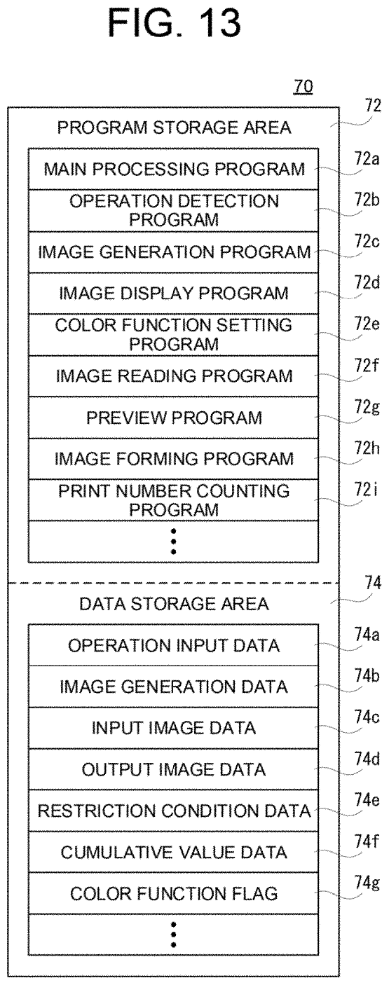

The display control circuit 18 includes a graphics processing unit (GPU), a video random access memory (VRAM), and the like. The GPU, under instructions from the CPU 12, uses image generation data 74b (see FIG. 13) stored in the RAM 14 to generate, in the VRAM, display image data for displaying various screens on the display 22, and outputs the generated display image data to the display 22. For example, a liquid crystal display (LCD) or an electro-luminescence (EL) display can be used as the display 22.

The operation button detection circuit 24 outputs operation signals or operation data to the CPU 12 in response to operations performed with respect to the operation buttons 26a described above.

The communication circuit 50 is a communication circuit for connecting to a network such as the Internet. The communication circuit 50 is a wired communication circuit or a wireless communication circuit, and communicates via the network with an external computer, such as a server, according to an instruction from the CPU 12.

The electrical configuration of the image forming device 10 shown in FIG. 2 is merely an example, and is not necessarily limited to this. For example, a connector such as a memory slot, to which various recording media such as a secure digital (SD) card or a universal serial bus (USB) memory can be installed, may be provided.

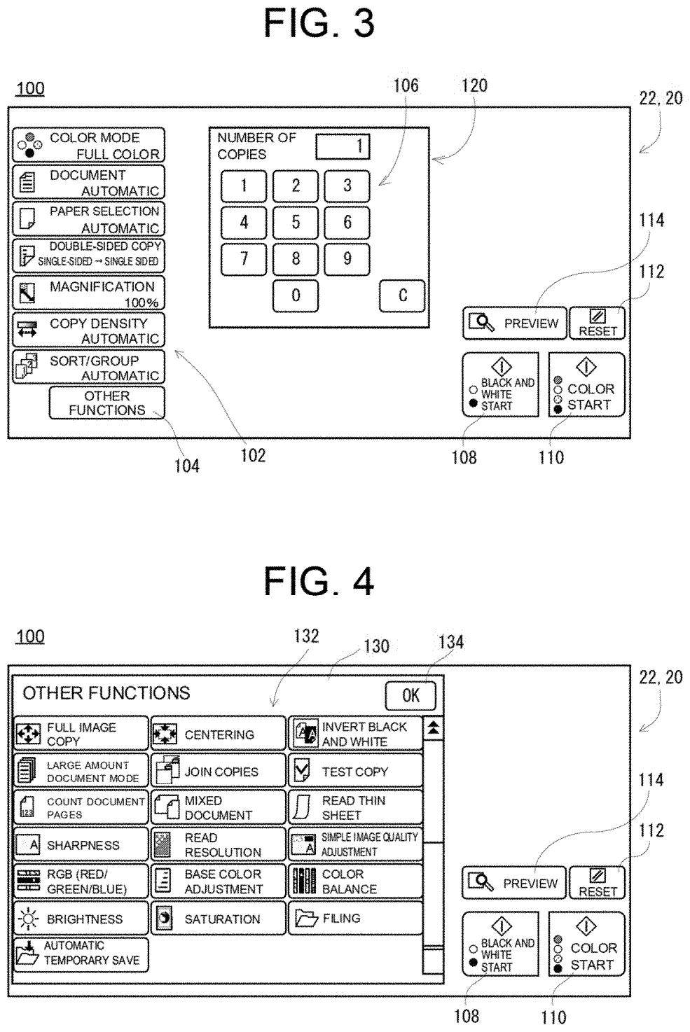

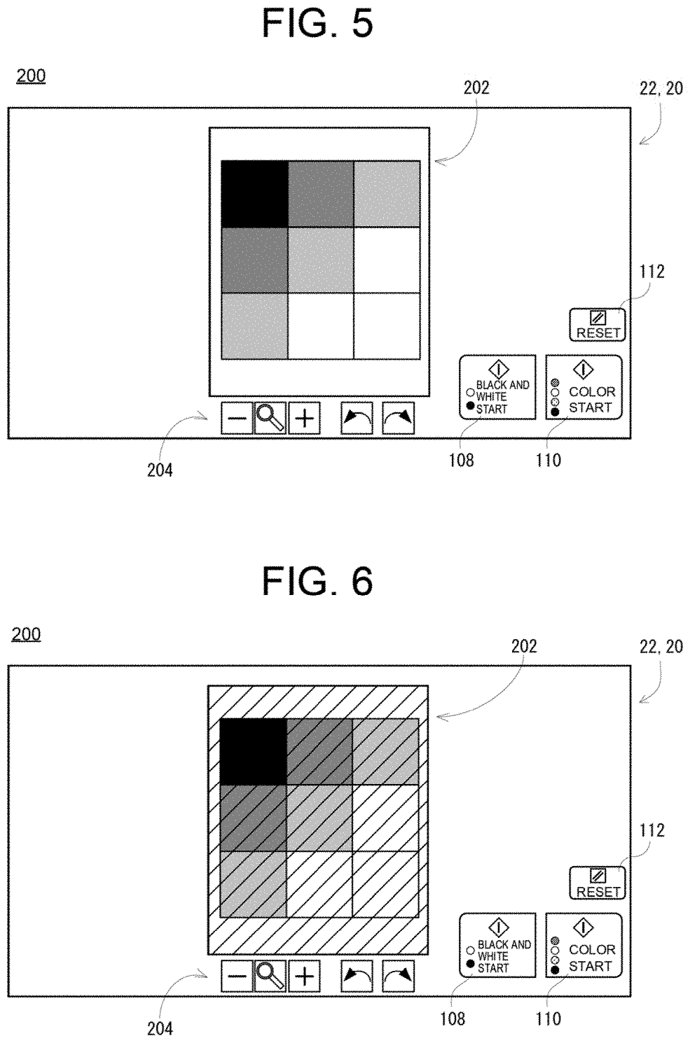

Hereinafter, an operation example of a copy setting screen 100 and of the image forming device 10 will be described with reference to FIG. 3 to FIG. 6. FIG. 3 is a diagram showing a first example of the copy setting screen 100. FIG. 4 is a diagram showing a second example of the copy setting screen 100. FIG. 5 is a diagram showing a first example of a preview screen 200. FIG. 6 is a diagram showing a second example of the preview screen 200.

The home screen is displayed on the display 22 when the power of the image forming device 10 is turned on, when the image forming device 10 is set from the power reduction mode to the normal mode, or when the home key is operated. When the user selects a desired job on the home screen, a setting screen for setting the operation conditions relating to the selected job is displayed on the display 22.

For example, when a copy job is selected on the home screen, the processing relating the copy function starts, and a copy setting screen 100 such as that shown in FIG. 3 is displayed on the display 22. The copy setting screen 100 is a screen for setting the operation conditions of the copy job. FIG. 3 shows a basic state of the copy setting screen 100, in which various keys and the like are not selected. That is to say, in the basic state, each of the settings is in a default state.

The copy setting screen 100 is provided with (displays) software keys such as function selection keys 102, another functions selection key 104, a numeric keypad 106, a black and white start key 108, a color start key 110, a reset key 112, and a preview key 114.

The function selection keys 102 are displayed on the left end of the copy setting screen 100. A plurality of function selection keys 102 are provided, which are disposed side by side in the up-and-down direction. Each of the plurality of function selection keys 102 correspond to the major operation conditions or the major functions related to a copy job. Specifically, the copy setting screen 100 displays function selection keys 102 for performing detailed settings (or selections) that respectively relate to the color mode setting, document orientation, sheet selection, double-sided copying, magnification, copy density, and the output method of the printed article (sorting/individual groups). Furthermore, the copy setting screen 100 displays the other functions selection key 104 for performing detailed settings that respectively relate to functions other than the major functions described above (other functions).

Note that the color mode refers to the color information of an output image. The color mode (or color information) can be set to color, black and white (monochrome), and an automatic setting. Further, monochrome images include black and white binary images and grayscale images. If the color mode is set to color, color printing of the document is selected. Note that, even if color is selected as the color mode, monochrome printing is executed if the black and white start key 108 is touched. If black and white is selected as the color mode, monochrome printing of the document is selected. If the color mode is set to the automatic setting, an auto color selection (ACS) determination processing is performed, which determines whether a document is in black and white or in color, and the selection results in printing (in black and white or in color) being performed according to the determination result. Note that, even if the document is determined as a color document, monochrome printing is executed if the black and white start key 108 is touched. The ACS determination processing is already well known, and does not represent content which is essential to the present invention. Therefore, the detailed description is omitted.

The numeric keypad 106 represents numeric keys which are provided inside a copy number setting area 120, which is displayed in the center of the copy setting screen 100. When the numeric keypad 106 is touched, the touched number is displayed in a numeric keypad input display field above the numeric keypad 106. That is to say, the number of copies is set.

The start key for black and white printing (hereinafter, referred to as “black and white start key”) 108 and the start key for color printing (hereinafter, referred to as “color start key”) 110 are displayed or provided in a lower-right corner area of the copy setting screen 100. The black and white start key 108 and the color start key 110 are keys for causing the image forming device 10 to start predetermined operations. When the black and white start key 108 is touched (selected or operated), monochrome printing within the copy function, that is to say, black and white copying, is started. Furthermore, when the color start key 110 is touched (selected or operated), color printing within the copy function, that is to say, color copying, is started.

When the black and white copying starts (is executed), the CPU 12 issues a document read instruction to the image reader 30. Moreover, the CPU 12 generates, from the read image data corresponding to the document read by the image reader 30, black and white output image data reflecting the various settings. Then, the CPU 12 causes the image former 32 to execute black and white image forming processing according to the output image data.

Furthermore, when the color copying starts (is executed), the CPU 12 issues a document read instruction to the image reader 30. Moreover, the CPU 12 generates, from the read image data corresponding to the document read by the image reader 30, color output image data reflecting various settings. Then, the CPU 12 causes the image former 32 to execute color image forming processing according to the output image data.

The processing that generates black and white or color output image data reflecting various settings from the read image data, and the black and white or color image forming processing according to the output image data are already known. Further, because these are outside the essential content of the present invention, the detailed description is omitted.

Furthermore, even if the document is a color document, the output image is black and white when black and white copying is executed. In addition, if the color mode is set to the automatic setting, if the document is a black and white document, black and white image forming processing is executed even when color copying is executed, and therefore, the output image is in black and white.

The reset key 112 is displayed or provided on the right end of the copy setting screen 100 above the color start key 110. The reset key 112 is a key for canceling a predetermined operation which is currently being executed by the image forming device 10, or reinitializing the operation conditions which have been set. For example, if the reset key 112 is touched, the job currently being executed is interrupted or canceled. Furthermore, when the reset key 112 is touched, the settings relating to the operation conditions (including various functions) of the copy job set on the copy setting screen 100 are reinitialized, such that the default state is restored.

The preview key 114 is displayed or provided on the left side of the reset key 112, and above the black and white start key 108 and the color start key 110. The preview key 114 is a key for causing the image reader 30 to read a document, and to display a preview image corresponding to the read document on the display 22.

As described above, as shown in FIG. 4, when the other functions selection key 104 is touched, a copy setting screen 100 that displays a window or screen for selecting other functions (hereinafter, referred to as “function selection window”) 130 in front of the function selection keys 102 and the other functions selection key 104 is displayed on the display 22. That is to say, the function selection window 130 is displayed on the display 22 as a popup. As shown in FIG. 4, the window is displayed with a size and position that does not overlap with the black and white start key 108, the color start key 110, the reset key 112, and the preview key 114.

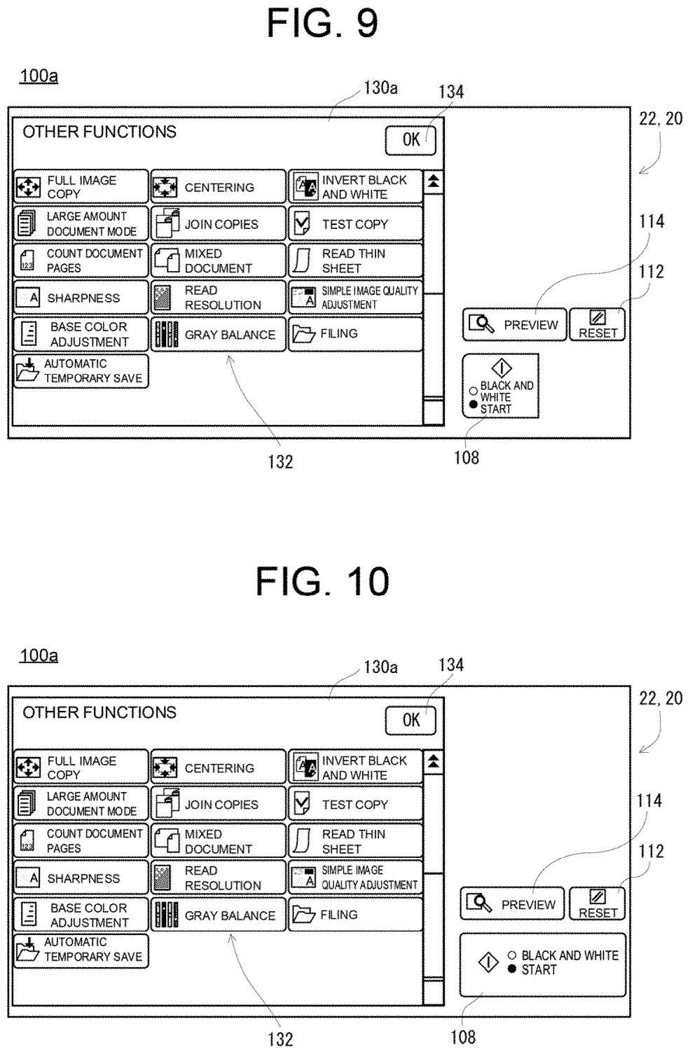

The function selection window 130, which is displayed when the color function is usable, is sometimes referred to as “color usable function selection window 130” in order to make a distinction with a function selection window 130a described below, which is displayed when the color function is unusable (see FIGS. 9 and 10).

The function selection window 130 is a screen (window) for performing detailed settings relating to each of the other functions, and is provided with a plurality of function selection keys 132 and an OK key 134. As described above, the other functions refer to functions different from those that can be set using the function selection keys 102. In other words, other functions are functions other than the major functions included in a copy job.

The plurality of function selection keys 132 are respectively software keys which are provided corresponding to each of a plurality of functions, and are disposed side-by-side in the up-and-down and left-and-right directions inside the display area of the function selection window 130. When one of the function selection keys 132 is touched, processing that performs detailed settings with respect to the function corresponding to the touched function selection key 132 is executed.

The OK key 134 is a software key, and is assigned a function that causes the function selection window 130 to no longer be displayed. When the OK key 134 is touched, the function selection window 130 is no longer displayed, and a copy setting screen 100 such as that shown in FIG. 3 is displayed on the display 22.

In the present embodiment, the function selection window 130 does not overlap with the black and white start key 108, the color start key 110, the reset key 112, and the preview key 114. Therefore, key operations with respect to these buttons can be accepted even if the function selection window 130 is displayed on the display 22. In another embodiment, it is possible for key operations with respect to the black and white start key 108, the color start key 110, the reset key 112, and the preview key 114 to not be accepted when the function selection window 130 is displayed on the display 22.

Furthermore, as described above, when the preview key 114 is touched, a document set inside the manual document feeder 34 or a document placed on the document table is read (that is to say, scanned) by the image reader 30. As shown in FIG. 5 or FIG. 6, a preview screen 200 including a preview image 202 corresponding to the read document is displayed on the display 22. At this time, the preview image 202 is displayed in color or in grayscale, depending on the color information of the document and the color mode.

Specifically, in the copy function, if a color document is scanned while the color mode is set to color, or the color mode is set to the automatic setting, a preview screen 200 including a color preview image 202 as shown in FIG. 5 is displayed on the display 22. Note that, even if color is selected as the color mode, a grayscale preview image 202 is displayed if the document is a monochrome document (see FIG. 6).

As shown in FIG. 5, the preview screen 200 displays (or includes) the preview image 202 in the center of the screen. Software keys 204 for executing operations relating to the preview image 202 are provided below the preview image 202. Although the detailed description is omitted, when the keys 204 are touched, the preview image 202 is enlarged or reduced, or the preview image 202 is rotated (by 90 degrees to the left, or by 90 degrees to the right). Furthermore, similarly to the copy setting screen 100, the black and white start key 108 and the color start key 110 is displayed or provided in a lower-right corner area of the preview screen 200. The reset key 112 is displayed or provided above the color start key 110.

As can be seen by comparison with the copy setting screen 100, in the present embodiment, the preview key 114 is not displayed or provided on the preview screen 200. In another embodiment, an additional read key may be displayed on the preview screen 200 instead of the preview key 114. This is because, when a document placed on the document table is scanned, another document may sometimes be placed on the document table and scanned after the scan is completed. Furthermore, this is also because, when a document placed in the manual document feeder 34 is scanned in a state where an additional read mode is turned on, another document may be placed in the manual document feeder 34 and scanned after the scan is completed.

Moreover, if a monochrome document is scanned while the color mode is set to black and white, or the color mode is set to the automatic setting, a grayscale preview image 202 is displayed as shown in FIG. 6. Note that, even if the document is a color document, a grayscale preview image 202 is displayed if the color mode is set to black and white.

The preview screen 200 shown in FIG. 6 is the same as the preview screen 200 shown in FIG. 5, except for the preview image 202 being displayed in grayscale. Therefore, a duplicate description is omitted.

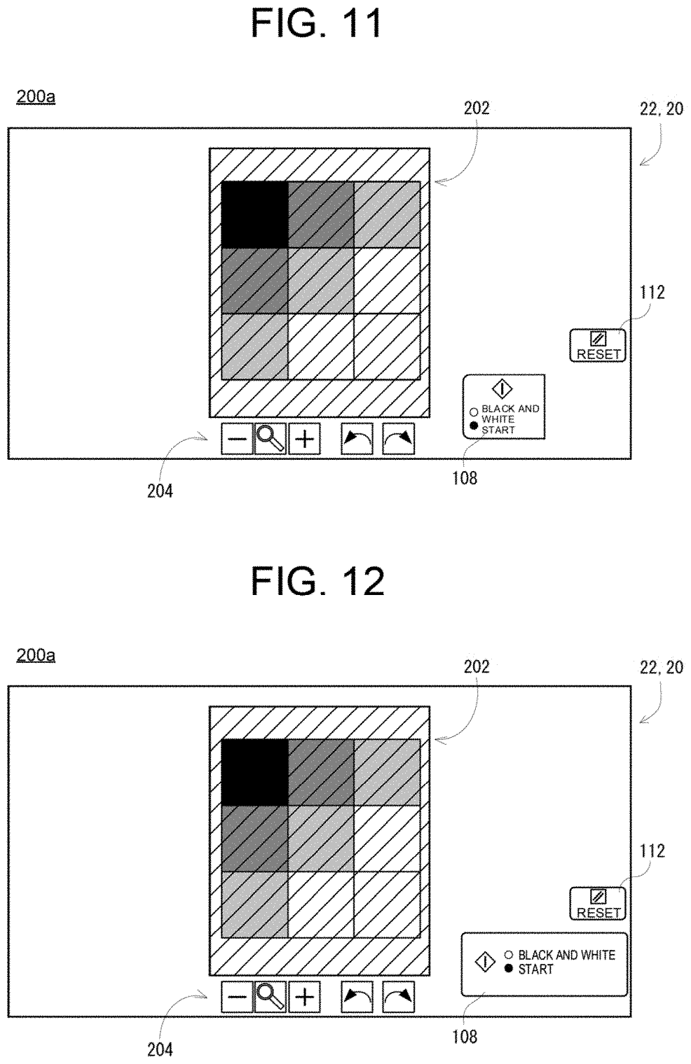

Furthermore, in FIG. 6 (and similarly in FIG. 11 and FIG. 12 described below), diagonal lines are added to the preview image 202 to indicate that the preview image 202 is displayed in grayscale.

In the image forming device 10 described above, an administrator may sometimes prohibit color printing within the image forming device 10, prohibit color printing within the copy function, restrict the number of sheets capable of being printed in color in the image forming device 10, or an error may occur in which only color printing is prevented from being performed.

If color printing is prohibited in the image forming device 10, in addition to being unable to execute color printing (that is to say, color copying) within the copy function, color printing is unable to be performed when printing is executed by an external computer. Furthermore, color printing is unable to be performed when printing is executed with respect to file data stored in an external memory such as a USB memory equipped to the image forming device 10.

Furthermore, when color printing (that is to say, color copying) is prohibited within the copy function, color copying cannot be executed. Although the detailed description is omitted, in another embodiment, an administrator may set whether or not color copying is prohibited for each user. In this case, the image forming device 10 stores, in association with the user identifications (IDs), information relating to whether or not color copying is prohibited (here, referred to as “color copying availability information”. When a user logs into the image forming device 10, the image forming device 10 refers to the color copying availability information corresponding to the user ID, and determines whether or not color copying is prohibited.

An administrator sets whether or not the number of sheets capable of being printed in color in the image forming device 10 is restricted. If the number of sheets capable of being printed in color is restricted, the number of sheets that can be printed in color (hereunder, referred to as “restriction number”) is set. The administrator sets the restriction number per day or per month. In another embodiment, the administrator may set the restriction number per day or per month for each user. In this case, the image forming device 10 stores, in association with the user IDs, information relating to the number of sheets that have been printed in color (cumulative value). When a user logs into the image forming device 10, if information relating to the cumulative value is stored corresponding to the user ID, the image forming device 10 refers to the cumulative value and the restriction number corresponding to the user ID to determine whether or not color printing in the image forming device 10 is restricted.

The present embodiment describes only the copy function. However, because color printing becomes restricted in the image forming device 10, the number of printed sheets includes, in addition to color copies, the number of sheets from cases where color printing is performed with respect to data received from an external device (such as print data and fax data) and data which has been filed in the image forming device 10 (stored in the HDD 28).

In the present embodiment, an example of a case where an error which prevents only color printing from being executed has occurred is a case where at least one among the yellow, magenta, or cyan toner has run out, but the black toner has not run out. In this case, color printing cannot be executed. However, monochrome printing can be executed. More specifically, the occurrence of a toner outage of toner used for color printing can be determined based on the output from a toner density detection sensor for each type of toner. The method of determining whether the toner has run out is already known. Therefore, the detailed description is omitted.

Furthermore, another example of a case where an error which prevents only color printing from being executed has occurred is a case where trouble (an error) has occurred in the image forming station for color printing, but an error has not occurred in the image forming station for monochrome printing (for black). In this case, color printing cannot be executed even if the color toner has not run out. The method of determining whether an error has occurred in the image forming station for color printing is already known. Therefore, the detailed description is omitted.

As described above, color printing within the image forming device 10 being prohibited, color printing within the copy function of the image forming device 10 being prohibited, the number of sheets capable of being printed in color in the image forming device 10 being restricted, and only color printing being prevented from being executed in the image forming device 10 are each conditions that restrict the execution of color printing (hereinafter, referred to as “restriction conditions”).

If any of the restriction conditions are met within the image forming device 10, color printing is prohibited, or the color function cannot be used (hereinafter, these cases are sometimes collectively referred to as “color unusable”. Furthermore, in contrast to the “color unusable” state, those cases where color printing is not prohibited, or the color function can be used, are sometimes collectively referred to as “color usable”).

In such cases, color printing is not executed even when the color start key 110 is touched. Conventionally, the user is notified that the pressed key (here, the color start key 110) is unusable.

However, if the copy setting screen 100 or the preview screen 200 is displayed in the same manner as a case where color printing can be performed even though the color start key 110 is unusable, the user learns that the color start key 110 is unusable, that is to say, that color printing cannot be executed, only after performing a key operation. Therefore, the key operation is wasted. Furthermore, if the copy setting screen 100 or the preview screen 200 is displayed in the same manner as a case where color printing can be performed even though the color start key 110 is unusable, the user may sometimes mistakenly touch the color start key 110 instead of the black and white start key 108 despite knowing that color printing cannot be executed.

In order to avoid such an inconvenience, information relating to color printing (in this embodiment, a key or icon) is not displayed in the color unusable state. Hereinafter, each of the screens will be described. However, description of the content already described will be omitted.

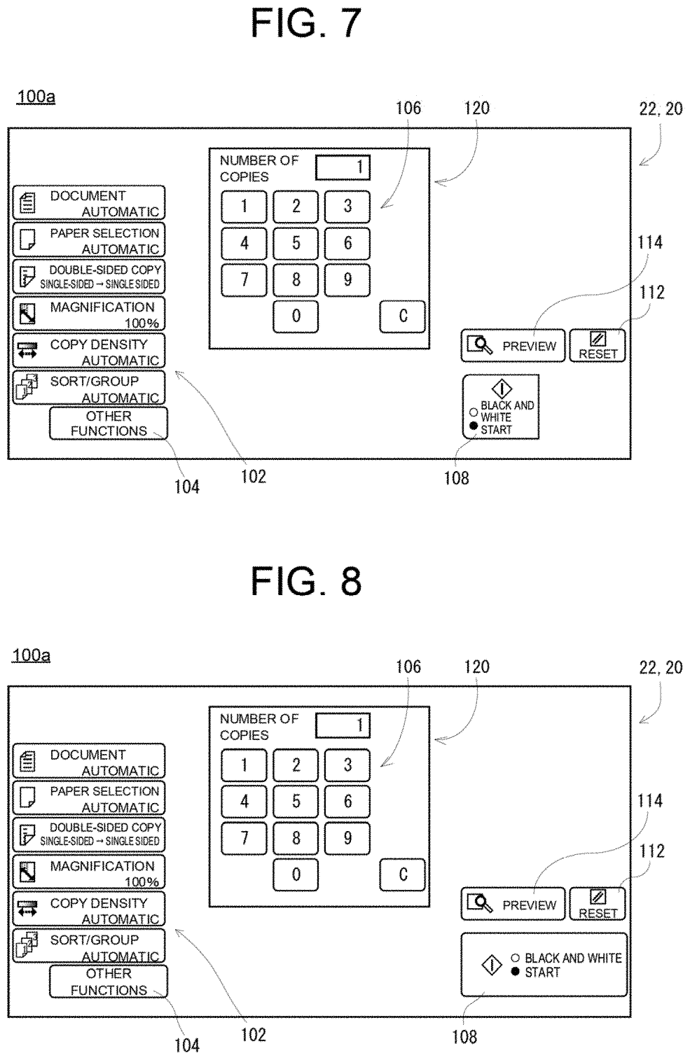

FIG. 7 shows an example of a copy setting screen 100a in the color unusable state. As can be seen by comparison with the copy setting screen 100 in FIG. 3, in the copy setting screen 100a, the function selection key 102 for setting the color mode is not displayed, and the color start key 110 is not displayed. That is to say, in the copy setting screen 100a, the function selection key 102 for setting the color mode and the color start key 110 are not provided.

Therefore, in the color unusable state, because the keys (102 and 110) relating to color operation are not provided on the copy setting screen 100a, erroneous operations by a user can be prevented in advance.

In a case where an error that prevents only color printing from being executed has occurred, color printing is possible once the error is resolved. Therefore, a message containing at least the content of the error or an indication that color printing can be performed once the error is resolved may be displayed in a vacant area such as the area in which the color start key 110 is not displayed.

Furthermore, as shown in FIG. 8, if the black and white start key 108 is displayed enlarged, the operability of the black and white start key 108 can be improved. In FIG. 8, the black and white start key 108 is displayed horizontally lengthened such that the vacant area created as a result of the color start key 110 not being displayed is filled.

Moreover, FIG. 9 shows a case where a function selection window 130a (hereinafter, referred to as “color unusable function selection window 130a”) is displayed in the copy setting screen 100a when color operation is unusable. As can be seen by comparison with the function selection window 130 displayed in the copy setting screen 100 in FIG. 4, the function selection keys 132 for setting color-dedicated functions are not displayed in the function selection window 130a shown in FIG. 9. Note that the function and display of the function selection key 132 for adjusting the color balance is changed to a function selection key 132 for adjusting the gray balance.

Here, color-dedicated functions represent functions which include red, green, and blue (RGB) adjustment, color copy settings relating to color balance adjustment, brightness adjustment, and saturation adjustment. In the RGB adjustment function, the color of the selected color (R, G, or B) is adjusted in the image. In the color copy settings within the color balance adjustment function, the color characteristics, gradient, and density of the yellow, magenta, cyan, and black colors are adjusted. In the brightness adjustment function, the brightness of the entire image is adjusted. In the saturation adjustment function, the saturation of the entire image is adjusted.

Furthermore, as shown in FIG. 10, if the black and white start key 108 is displayed enlarged in the same manner as the copy setting screen 100a shown in FIG. 8, the operability of the black and white start key 108 can be improved.

Moreover, FIG. 11 shows an example of a preview screen 200a in the color unusable state. As can be seen by comparison with the preview screen 200 shown in FIG. 5 or FIG. 6, the preview image 202 is shown in grayscale in the preview screen 200a shown in FIG. 11 irrespective of whether the document is a color document or a monochrome document.

Therefore, even when a color document is read, the preview image 202 corresponding to the read image is displayed in grayscale. Consequently, a misunderstanding does not occur where the user is under the impression that color printing is possible.

Furthermore, as shown in FIG. 12, if the black and white start key 108 is displayed enlarged in the same manner as the copy setting screen 100a shown in FIG. 8 and FIG. 10, the operability of the black and white start key 108 can be improved.

FIG. 13 is a diagram showing an example of a memory map 70 of the RAM 14 shown in FIG. 2. As shown in FIG. 7, the RAM 14 includes a program storage area 72 and a data storage area 74. The program storage area 72 of the RAM 14 stores control programs for controlling the image forming device 10. The control programs include a main processing program 72a, an operation detection program 72b, an image generation program 72c, an image display program 72d, a color function setting program 72e, an image reading program 72f, a preview program 72g, an image forming program 72h, and a print number counting program 72i.

The main processing program 72a is a program for executing the overall processing relating to the image forming device 10. The operation detection program 72b is a program for detecting operations with respect to each of the units of the image forming device 10. For example, the operation detection program 72b is a program for acquiring touch coordinate data output from the touch panel 20, and detecting that the software keys included on the various screens displayed on the display 22 have been operated. Furthermore, the operation detection program 72b is also a program for detecting operation inputs from the operation buttons 26a.

The image generation program 72c is a program for controlling the GPU and using the image generation data 74b described below to generate display image data corresponding to the various screens (such as 100, 100a, 130, 130a, 200, and 200a). Furthermore, the image display program 72d is a program for outputting the display image data generated according to the image generation program 72c on the display 22.

The color function setting program 72e is a program for determining whether or not a restriction condition is met, setting the color usable state if the restriction condition is not met, and setting the color unusable state if the restriction condition is met.

The image reading program 72f is a program for controlling the image reader 30, reading (scanning) an image of a document transported by means of the ADF or an image of a document placed on the document placement table, and outputting an image signal corresponding to the read image, that is to say, read image data, to the CPU 12. When the CPU 12 receives the read image data, it stores the received read image data as input image data 74c in the data storage area 74.

The preview program 72g is a program for scanning a document in response to the user touching the preview key 114, and displaying the preview screens 200 and 200a, which include the preview image 202 corresponding to the scanned document, on the display 22. Therefore, when the preview program 72g is executed, the image generation program 72c, the image display program 72d, and the image reading program 72f are also executed.

The image forming program 72h is a program for controlling the image former 32, and forming a multi-color or single-color image corresponding to the image data, such as the output image data 74d described below, on a recording medium (sheet). Although the detailed description is omitted, when the image forming processing is executed, image processing is applied with respect to the input image data 74c, thereby generating the output image data 74d.

The print number counting program 72i is a program for counting the number of sheets that have been printed in color in the image forming device 10. Although the detailed description is omitted, when a restriction number is set as described above, the count value of the number of sheets that have been printed in color is reset after each day or each month in which the restriction applies.

Although not shown, the program storage area 72 also stores other programs for executing various functions provided in the image forming device 10.

Furthermore, the data storage area 74 of the RAM 14 stores operation input data 74a, image generation data 74b, input image data 74c, output image data 74d, restriction condition data 74e, and cumulative value data 74f. Furthermore, the data storage area 74 stores a color function flag 74g.

The operation input data 74a is at least one of touch coordinate data and operation data detected or acquired according to the operation detection program 72b, and is stored in the data storage area 74 according to a time series.

The image generation data 74b is data that includes polygon data or texture data for generating display image data. Furthermore, the image generation data 74b includes image data of the software keys and the like.

The input image data 74c represents image data such as read image data that has been read by the image reader 30, image data transmitted from an external computer, and the like. The output image data 74d represents image data for printing which is generated based on the input image data 74c.

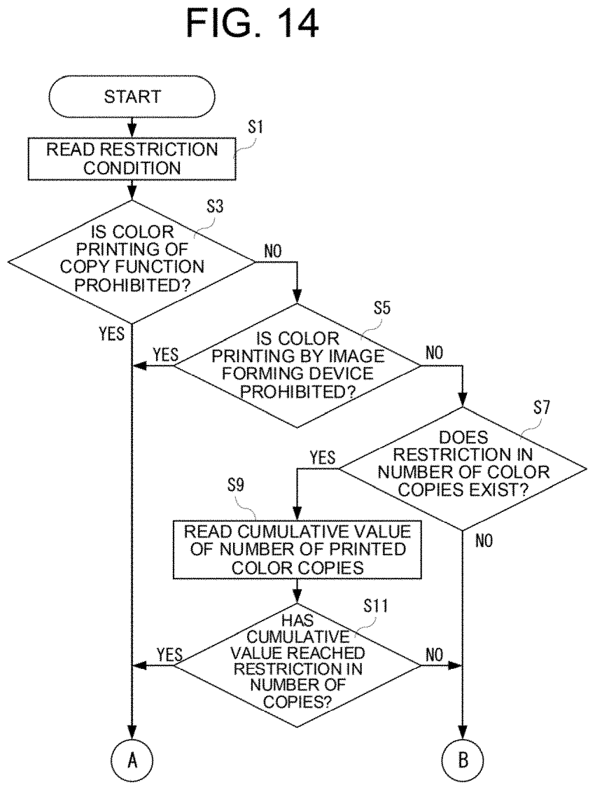

The restriction condition data 74e represents data which relates to information (identification information, and the like) relating to the restriction condition that has been met in a case where one of the restriction conditions among the set restriction conditions, namely color printing within the image forming device 10 being prohibited, color printing within the copy function being prohibited, and the number of sheets capable of being printed in the image forming device 10 being restricted, is met. The restriction condition data 74e is stored or saved in the HDD 28, and is read from the HDD 28 and written to (or stored in) the RAM 14 when processing relating to the copy function is executed (see FIG. 14 to FIG. 21). Therefore, the restriction condition data 74e is not stored in the HDD 28 and the data storage area 74 when none of the restriction conditions are met. Furthermore, because the restriction condition which indicates that an error that prevents only color printing from being executed has occurred is not content which is set in advance, it is not included in the restriction condition data 74e.

The cumulative value data 74f represents numerical value data relating to the cumulative value of the number of sheets in which printing has been executed in color in the image forming device 10. The cumulative value data 74f is stored or saved in the HDD 28, and is read from the HDD 28 and written to (or stored in) the RAM 14 when processing relating to the copy function is executed (see FIG. 14 to FIG. 21). Note that the cumulative value data 74f is reset by an administrator operation or after the period over which the number of sheets capable of being printed in color is restricted elapses.

In the image forming device 10, although the number of sheets in which printing has been executed in monochrome is also counted, this does not represent content which is essential to the present invention. Therefore, the detailed description is omitted.

The color function flag 74g is a flag for determining whether the current state is color usable or color unusable. The color function flag 74g is turned on when in the color usable state, and turned off when in the color unusable state. In the present embodiment, the color function flag 74g is turned on when processing relating to the copy function (FIG. 14 to FIG. 21) starts.

Although not shown, the data storage area 74 stores other data necessary for executing the control programs, and is provided with timers (counters) and other flags necessary for executing the control programs.

FIG. 14 to FIG. 21 are flow diagrams showing an example of the processing relating to the copy function of the CPU 12 shown in FIG. 2. The processing relating to the copy function starts when a copy job is selected on the home screen.

As shown in FIG. 14, when the processing relating to the copy function starts, in step S1 the CPU 12 reads the restriction conditions. Here, the CPU 12 reads the restriction condition data 74e stored or saved in the HDD 28, and writes (or stores) the data in the data storage area 74 of the RAM 14.

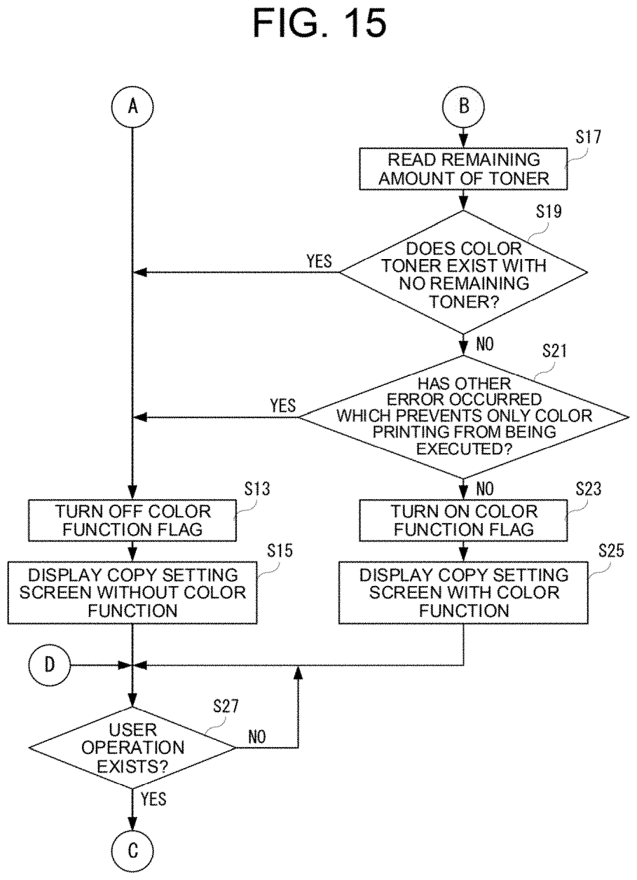

In the following step S3, the restriction condition data 74e is referenced to determine whether or not color printing within the copy function is prohibited. If the result of step S3 is “YES”, that is to say, if color printing within the copy function is prohibited, the process proceeds to step S13 shown in FIG. 15. On the other hand, if the result of step S3 is “NO”, that is to say, if color printing within the copy function is not prohibited, in step S5 the restriction condition data 74e is referenced to determine whether or not color printing is prohibited within the image forming device 10.

If the result of step S5 is “YES”, that is to say, if color printing is prohibited within the image forming device 10, the process proceeds to step S13. On the other hand, if the result of step S5 is “NO”, that is to say, if color printing is not prohibited within the image forming device 10, in step S7 the restriction condition data 74e is referenced to determine whether or not a restriction exists with respect to the number of sheets capable of being printed in color in the image forming device 10.

If the result of step S7 is “NO”, that is to say, if a restriction does not exist with respect to the number of sheets capable of being printed in color in the image forming device 10, the process proceeds to step S17 shown in FIG. 15. On the other hand, if the result of step S7 is “YES”, that is to say, if a restriction exists with respect to the number of sheets capable of being printed in color in the image forming device 10, in step S9 a cumulative value of the number of sheets that have been printed in color is read. In step S9, the CPU 12 reads the cumulative value data 74f saved in the HDD 28, and writes the data to the data storage area 74 of the RAM 14.

Next, in step S11, it is determined whether or not the cumulative value has reached the restriction number. That is to say, the CPU 12 determines whether or not the restriction with respect to the number of sheets capable of being copied in color is met. If the result of step S11 is “YES”, that is to say, if the cumulative value has reached the restriction number, it is determined that the restriction in the number of sheets capable of being copied in color is met, and the process proceeds to step S13. On the other hand, if the result of step S11 is “NO”, that is to say, if the cumulative value has not reached the restriction number, it is determined that the restriction in the number of sheets capable of being copied in color is not met, and the process proceeds to step S17.

As shown in FIG. 15, the color function flag 74g is turned off in step S13. Note that, as described above, the color function flag 74g is turned on when the processing relating to the copy function is first started. In the following step S15, the copy setting screen without color functions, that is to say, the color unusable copy setting screen 100a as shown in FIG. 7 or FIG. 8 is displayed on the display 22. Then, the process proceeds to step S27.

Furthermore, in step S17, the remaining amount of toner is read. In step S19, it is determined whether or not a color toner exists in which no toner remains. If the result of step S19 is “YES”, that is to say, if a color toner exists in which no toner remains, the process proceeds to step S13. On the other hand, if the determination in step S19 is “NO”, that is to say, if a color toner does not exist in which no toner remains, in step S21 it is determined whether or not another error which prevents only color printing from being executed has occurred. That is to say, the CPU 12 determines, among the errors which prevent only color printing from being executed, whether or not another error other than a toner outage error relating to a color toner has occurred.

If the result of step S21 is “YES”, that is to say, another error which prevents only color printing from being executed has occurred, the process proceeds to step S13. If the result of step S21 is “NO”, that is to say, another error which prevents only color printing from being executed has not occurred, it is determined that none of the restriction conditions are met. Then, the color function flag 74g is turned on in step S23. Note that the processing of step S23 is skipped when the color function flag 74g is already turned on. Then, in step S25, a copy setting screen having color functions, that is to say, the basic state of the copy setting screen 100 as shown in FIG. 3, is displayed on the display 22. Then, the process proceeds to step S27.

In step S27, it is determined whether or not a user operation exists. Here, the CPU 12 determines whether current operation input data 74a has been stored in the data storage area 74.

Although the detailed illustration and description is omitted, processing that detects the operation input data 74a, and stores the detected operation input data 74a in the data storage area 74 is executed in parallel with the processing relating to the copy function.

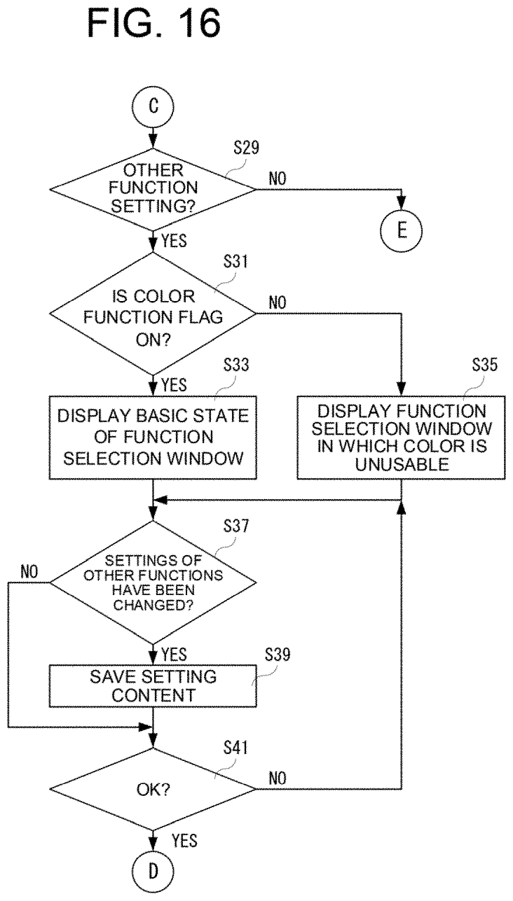

If the result of step S27 is “NO”, that is to say, if there is no user operation, the process returns to the same step S27. On the other hand, if the result of step S27 is “YES”, that is to say, if a user operation exists, it is determined in step S29 shown in FIG. 16 whether the operation relates to other function settings. Here, the CPU 12 determines, based on touch coordinate data, whether or not the other functions selection key 104 has been touched. In the following, whether or not a software key has been operated is determined in the same manner.

If the result of step S29 is “YES”, that is to say, if the operation relates to other function settings, it is determined in step S31 whether or not the color function flag 74g is on. If the result of step S31 is “YES”, in step S33 the color usable function selection window 130 is displayed. Then, the process proceeds to step S37. That is to say, by executing the processing of step S33, a copy setting screen 100 which includes the color usable function selection window 130 as shown in FIG. 4 is displayed on the display 22.

On the other hand, if the result of step S31 is “NO”, in step S35 the color unusable function selection window 130a is displayed. Then, the process proceeds to step S37. That is to say, by executing the processing of step S35, the color unusable copy setting screen 100a which includes the color unusable function selection window 130a as shown in FIG. 9 or FIG. 10 is displayed on the display 22.

In step S37, it is determined whether or not the settings of other functions have been changed. In step S37, the CPU 12 determines whether or not detailed settings relating to other functions have been changed. If the result of step S37 is “NO”, that is to say, if settings relating to other functions have not been changed, the process proceeds to step S41. On the other hand, if the result of step S37 is “YES”, that is to say, if settings relating to other functions have been changed, in step S39 the changed setting content is saved. Then, the process proceeds to step S41.

In step S41, it is determined whether or not the OK key 134 has been operated. If the result of step S41 is “NO”, that is to say, if the OK key 134 has not been operated, the process returns to step S37. On the other hand, if the result of step S41 is “YES”, that is to say, if the OK key 134 has been operated, the process proceeds to step S27 shown in FIG. 15.

Although not shown in FIG. 13, the data (function setting data) relating to other function settings is stored in the data storage area 74. In step S39, the function setting data is updated to function setting data including the changed content.

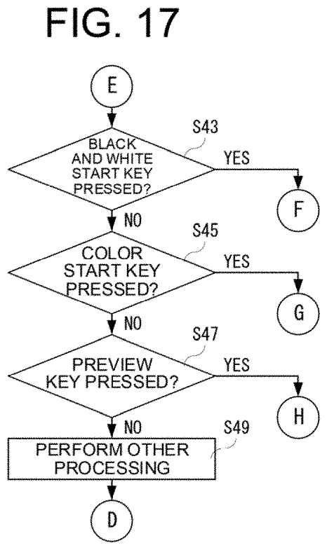

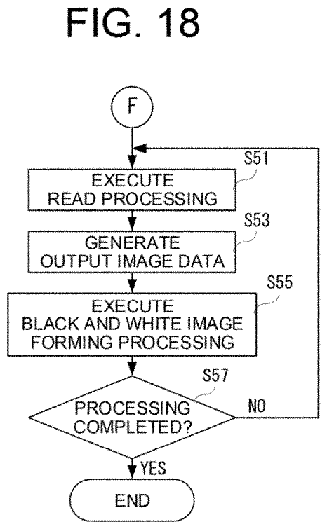

On the other hand, if the result of step S29 is “NO”, that is to say, if the operation does not relate to other function settings, as shown in FIG. 17, in step S43 it is determined whether or not the black and white start key 108 has been operated. If the result of step S43 is “YES”, that is to say, if the black and white start key 108 has been operated, the process proceeds to step S51 shown in FIG. 18. On the other hand, if the result of step S43 is “NO”, that is to say, if the black and white start key 108 has not been operated, in step S45 it is determined whether or not the color start key 110 has been operated. Note that if the color unusable copy setting screen 100a is displayed, the color start key 110 is not displayed. Therefore, the processing of step S45 is skipped, and the processing of step S47 is executed.

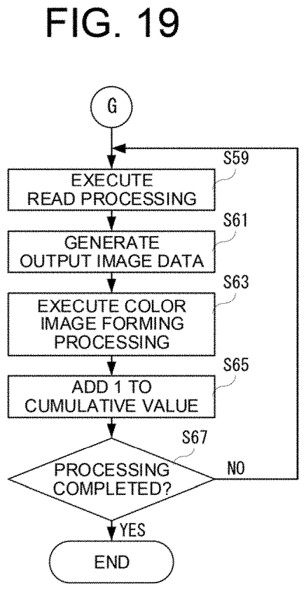

If the result of step S45 is “YES”, that is to say, if the color start key 110 has been operated, the process proceeds to step S59 shown in FIG. 19. On the other hand, if the result of step S45 is “NO”, that is to say, if the color start key 110 has not been operated, in step S47 it is determined whether or not the preview key 114 has been operated.

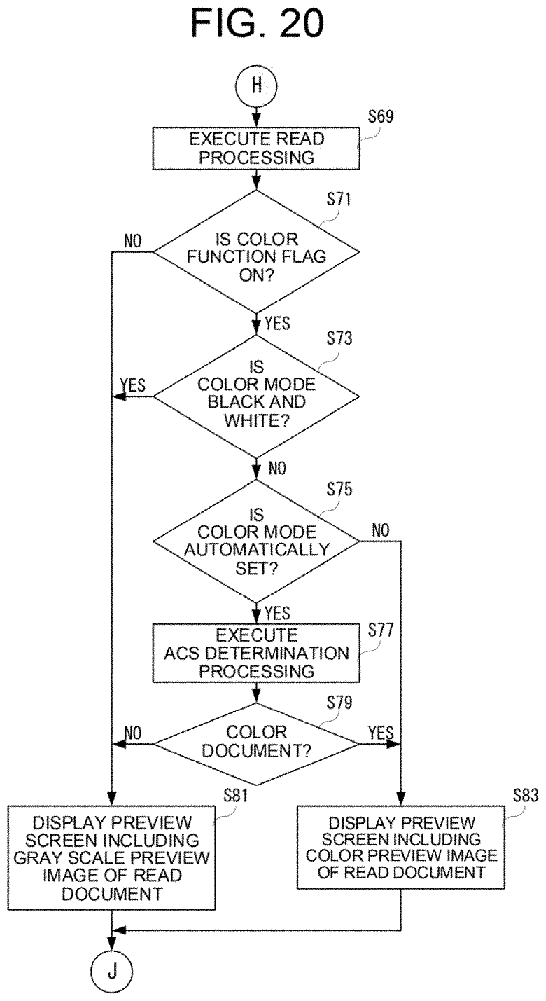

If the result of step S47 is “YES”, that is to say, if the preview key 114 has been operated, the process proceeds to step S69 shown in FIG. 20. On the other hand, if the result of step S47 is “NO”, that is to say, if the preview key 114 has not been operated, other processing is executed in step S49. Then, the process returns to step S27. In step S49, on the copy setting screen 100, detailed setting processing relating to the color mode settings, document orientation, double-sided copying, magnification, copy density, and selection of the output method of the printed article is executed in response to the function selection keys 102 and the like being touched. Further, in response to the numeric keypad 106 and the like being touched, setting processing relating to the number of copies is executed. In response to the reset key 112 being touched, processing that reinitializes the operation condition settings of the copy job selected on the copy setting screen 100 or on the copy setting screen 100a is executed, or processing that reinitializes other function settings is executed.

As described above, if the result of step S43 is “YES”, in step S51 shown in FIG. 18, document read processing is executed and the read image data is stored in the data storage area 74 as input image data 74c. In the following step S53, output image data 74d is generated from the input image data 74c. In step S55, black and white image forming processing is executed.

Then, in step S57, it is determined whether or not the copy job is completed. Here, the CPU 12 determines whether or not the set number of copies has been copied for all of the documents. If the result of step S57 is “NO”, that is to say, the copy job has not been completed, the process returns to step S51. On the other hand, if the result of step S57 is “YES”, that is to say, the copy job has been completed, the copy function processing ends.

In steps S51 to S57, the description is for a case where one copy is copied for each of a plurality of documents. However, in reality, when the read processing starts, the output image generation processing and the image forming processing are executed in parallel with the read processing. This same applies to steps S59 to S63 described below.

Furthermore, when the CPU 12 completes the copy function processing, it starts the copy function processing unless it returns to the home screen or switches to the power reduction mode. The same applies below in those cases the CPU 12 completes the copy function processing.

Furthermore, as described above, if the result of step S45 is “YES”, in step S59 shown in FIG. 19, document read processing is executed and the read image data is stored in the data storage area 74 as input image data 74c. In the following step S61, output image data 74d is generated from the input image data 74c. In step S63, color image forming processing is executed.

Next, in step S65, the cumulative value is incremented by 1. Here, the cumulative value data 74f is updated. Then, in step S67, it is determined whether or not the copy job is completed. If the result of step S67 is “NO”, that is to say, the copy job has not been completed, the process returns to step S59. On the other hand, if the result of step S67 is “YES”, that is to say, the copy job has been completed, the copy function processing ends.

Furthermore, as described above, if the result of step S47 is “YES”, in step S69 shown in FIG. 20, document read processing is executed and the read image data is stored in the data storage area 74 as input image data 74c.

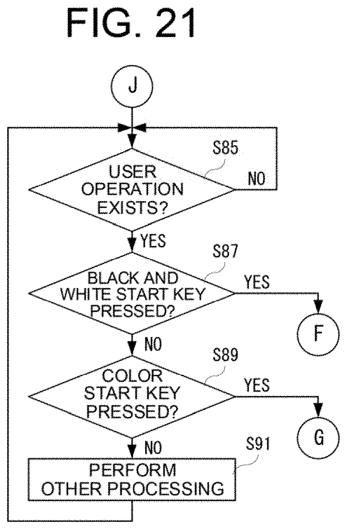

In the following step S71, it is determined whether or not the color function flag 74g is on. If the result of step S71 is “NO”, in step S81, the color unusable preview screen 200a as shown in FIG. 11 or FIG. 12, which includes a grayscale preview image of the read document, is displayed on the display 22. Then, the process proceeds to step S85 shown in FIG. 21. On the other hand, if the result in step S71 is “YES”, in step S73 it is determined whether or not the color mode has been set to black and white.

If the result of step S73 is “YES”, that is to say, the color mode is set to black and white, the process proceeds to step S81. Note that, in this case, in step S81 a preview screen 200 as shown in FIG. 6 is displayed. On the other hand, if the result in step S73 is “NO”, that is to say, the color mode is not set to black and white, in step S75 it is determined whether or not the color mode has been set to the automatic setting. If the result of step S75 is “NO”, that is to say, the color mode is not set to the automatic setting, it is determined that the color mode is set to color. In step S83, the preview screen 200 as shown in FIG. 5, which includes a color preview image of the read document, is displayed on the display 22. Then, the process proceeds to step S85.

On the other hand, if the result in step S75 is “YES”, that is to say, the color mode is set to the automatic setting, The ACS determination processing is executed in step S77. Then, in step S79, it is determined whether or not the document is a color document. If the result of step S79 is “NO”, that is to say, if the document is not a color document, the process proceeds to step S81. In this case, in step S81 a preview screen 200 as shown in FIG. 6 is displayed. On the other hand, if the result of step S79 is “YES”, that is to say, if the document is a color document, the process proceeds to step S83. In this case, in step S83 a preview screen 200 as shown in FIG. 5 is displayed.

As shown in FIG. 21, in step S85 it is determined whether or not a user operation exists. If the result of step S85 is “NO”, the process returns to the same step S85. On the other hand, if the result of step S85 is “YES”, in step S87 it is determined whether or not the black and white start key 108 has been operated. If the result of step S87 is “YES”, the process proceeds to step S51 shown in FIG. 18. On the other hand, if the result of step S87 is “NO”, in step S89 it is determined whether or not the color start key 110 has been operated. If the result of step S89 is “YES”, the process proceeds to step S59 shown in FIG. 19. On the other hand, if the result of step S89 is “NO”, other processing is executed in step S91. Then, the process returns to step S85. In step S91, the preview image is enlarged or reduced, and the orientation of the preview image is changed. Although not shown, if the reset key 112 is touched on the preview screen 200 or 200a, the preview screen 200 or the preview screen 200a is no longer displayed, and the copy setting screen 100 or the copy setting screen 100a is displayed on the display 22. At this time, the input image data 74c corresponding to the scanned document is deleted.

Although illustration and the like is omitted since the contents are well known, the CPU 12 also executes, in parallel with the copy function processing shown in FIG. 14 to FIG. 21, processing (error detection processing) that detects the occurrence of errors such as paper jams, paper outages, and toner outages, and the occurrence of errors in the image forming stations. In the image forming device 10, when an error occurs and is detected, the copy function processing is interrupted, and the user or the like is also alerted of the contents of the error. Furthermore, in the image forming device 10, the interrupted copy function processing can be resumed once the error is resolved.

Note that, if an error which prevents only color printing from being executed occurs during execution of the color printing processing shown in FIG. 19 (steps S59 to S67) and the error cannot be resolved, the interrupted job can be continued by executing monochrome printing by touching the monochrome start key 108. Therefore, if an error which prevents only color printing from being executed occurs during execution of color printing, it is possible for the function selection keys 102 relating to color mode settings and the color start key 110 to no longer be displayed in the copy setting screen, which displays a message window for alerting the contents of the error.

Furthermore, although not illustrated or the like, if the home key is pressed to return to the home screen, the power reduction key is pressed to switch to the sleep mode, or a user operation is performed that displays a setting screen of a function other than the copy function (such as an email transmission function), the copy function processing ends.

According to the present embodiment, when the function of the color printing cannot be used, the software keys relating to the function of the color printing are not displayed. Therefore, erroneous operations can be prevented ahead of time.

Furthermore, according to the present embodiment, if the function of the color printing cannot be used, the preview image is displayed in grayscale irrespective of the setting contents relating to the color mode, even if the document is a color document. Therefore, a misunderstanding does not occur where the user is under the impression that color printing can be executed.

In the present embodiment, the color start key 110 is removed when the function of the color printing cannot be used. However, it is not limited to this.

For example, instead of removing the color start key 110, the display method of the design may be changed such that the key design is displayed with a reduced brightness, the colors of the key design are displayed inverted, or the key design is displayed greyed out. Furthermore, in addition to changing the display method of the design, a message that attracts the attention of the user may also be displayed. Also, in addition to changing the display method of the design, the size of the key may be relatively changed. An example of relatively changing the size of the key is the enlargement of the size of the black and white start key 108, and the reduction of the size of the color start key 110. These changes may be employed in combination. In this manner, erroneous operations are considered to be prevented as much as possible.

Furthermore, only the copy function was described in the embodiment above. However, the operation screens relating to functions that are not associated with printing, such as fax transmission, email transmission, internet fax (I-FAX) transmission, and document filing, are unchanged even when color printing is not possible.

Note that when data received from the outside or data saved on the body of the image forming device 10 (HDD 28) is printed, if color printing is prohibited in the image forming device 10 or the number of sheets capable of being printed in color in the image forming device 10 is restricted, the color-related information on the operation screen (such as the color start key 110) is not displayed according to the restriction conditions.

The numerical values, screens, and specific configurations and the like presented in the embodiment above are examples, and can be appropriately changed depending on the actual product.

Furthermore, the order in which the steps in the flow diagrams presented in the embodiment above are processed may be appropriately changed if the same results can be obtained. For example, the processing in step S3, step S5, step S7 to step S11, step S17 to step S19, and step S21, which determine whether or not each of the restriction conditions are met, may be executed in any order.

### DESCRIPTION OF REFERENCE NUMERALS

10 Image forming device
12 Central Processing Unit (CPU)
14 Random Access Memory (RAM)
20 Touch panel
22 Display
28 Hard Disk Drive (HDD)
30 Image reader
32 Image former

What is claimed is:

1. An image forming device capable of executing monochrome printing and color printing, comprising:
an operation screen displaying unit that displays an operation screen relating to a copy function;
a restriction condition determinator that determines whether or not a restriction condition that restricts the use of a function of the color printing within the copy function is met; and
a non-displaying unit that causes information relating to the function of the color printing to not be displayed on the operation screen if the restriction condition determinator determines that the restriction condition is met.

2. The image forming device according to claim 1, wherein
the restriction condition includes a first condition, which indicates that a setting that causes the function of the color printing within the copy function to be unusable has been set,
the restriction condition determinator determines whether or not the first condition is met, and
the non-displaying unit causes the information relating to the function of the color printing to not be displayed on the operation screen if the restriction condition determinator determines that the first condition is met.

3. The image forming device according to claim 1, wherein
the restriction condition includes a second condition, which indicates that a setting that causes the function of the color printing within the image forming device to be unusable has been set,
the restriction condition determinator determines whether or not the second condition is met, and
the non-displaying unit causes information relating to the function of the color printing to not be displayed on the operation screen if the restriction condition determinator determines that the second condition is met.

4. The image forming device according to claim 1, wherein
the restriction condition includes a third condition, which indicates that an upper limit has been set with respect to the number of sheets capable of being printed by the color printing,
the restriction condition determinator determines whether or not the third condition is met,
an upper limit determinator is further provided that determines whether or not the upper limit with respect to the number of sheets capable of being printed by the color printing has been reached if the restriction condition determinator determines that the third condition is met, and
the non-displaying unit causes information relating to the function of the color printing to not be displayed on the operation screen if the upper limit determinator determines that the upper limit with respect to the number of sheets capable of being printed by the color printing has been reached.

5. The image forming device according to claim 1, wherein
the restriction condition includes a fourth condition, which indicates that an error that prevents only the color printing from being executed has occurred,
the restriction condition determinator determines whether or not the fourth condition is met, and
information relating to the function of the color printing is not displayed on the operation screen if the restriction condition determinator determines that the fourth condition is met.

6. The image forming device according to claim 1, wherein
the information relating to the function of the color printing includes first operation information for instructing execution of the color printing within the copy function, and second operation information for performing settings relating to the color printing.

7. The image forming device according to claim 1, further comprising:
a scan executor that executes scanning of a document; and
a preview image displaying unit that displays a preview image corresponding to the document scanned by the scan executor, wherein
the preview image displaying unit displays the preview image corresponding to the document scanned by the scan executor in grayscale, irrespective of whether or not the document is a color document, if the restriction condition determinator determines that the restriction condition is met.

8. A non-transitory computer-readable recording medium storing a control program of an image forming device capable of executing monochrome printing and color printing, the control program causing a processor of the image forming device to implement:
displaying of an operation screen relating to a copy function on a displaying unit;
determining of a restriction condition in which it is determined whether or not a restriction condition that restricts the use of a function of the color printing within the copy function is met; and
making of information relating to the function of the color printing not displayed on the operation screen if it is determined in the determining of a restriction condition that the restriction condition is met.

9. A control method of an image forming device capable of executing monochrome printing and color printing, comprising:
(a) displaying of an operation screen relating to a copy function on a displaying unit;
(b) determining of a restriction condition in which it is determined whether or not a restriction condition that restricts the use of a function of the color printing within the copy function is met; and
(c) making of information relating to the function of the color printing not displayed on the operation screen if it is determined in (b) that the restriction condition is met.
